(19) United States
(12) Patent Application Publication
(10) Pub. No.: US 2024/0069697 A1
(43) Pub. Date: Feb. 29, 2024

(54) SYSTEM AND METHOD OF RENDERING USER INTERFACE COMPONENTS BASED ON USER INTERACTION

(71) Applicant: Microsoft Technology Licensing, LLC, Redmond, WA (US)

(72) Inventors: Rahul GUPTA, Bangalore (IN); Manoj KUMAR, Una (IN); Ankush SHARMA, Delhi (IN); Yash SONI, Dewas (IN)

(73) Assignee: Microsoft Technology Licensing, LLC, Redmond, WA (US)

(21) Appl. No.: 17/893,414

(22) Filed: Aug. 23, 2022

(51) Int. Cl. G06F 3/0484; G06F 9/451

(52) U.S. Cl. CPC G06F 3/0484; G06F 9/451

(57) ABSTRACT

A system and method for loading a user interface (UI) component of a UI screen on an as needed basis is conducted by examining a list of UI components included in the UI screen to identify a UI component having an associated replacement component, the replacement component imitating an appearance of the UI component but offering fewer functionalities than the UI component. The replacement component is then loaded in place of the UI component, before user interactions with the UI screen are examined to determine when the UI component is likely to be used. Responsive to determining that UI component is likely to be used in the near future, the replacement component is replaced with the UI component in the UI screen.

### BACKGROUND

Many user interface (UI) screens depicted in various applications include complex components. Some of these components require complicated calculations and take a lot of time and resources to render. As a result, rendering the UI screen requires significant time and resources. However, many of the complex components or portions of components displayed on UI Screens are not used by all users, and as such may not be used every time the UI screen is displayed. For example, a component may be used occasionally by a user, but not every time an application screen is rendered. Thus, a lot of time and computing resources are spent on rendering components that are only used occasionally and may not be used at all. This leads to unnecessary delay in the rendering of UI screens, a perception of slowness to the end user, as well as unnecessary use of processing, memory and other computing resources in rendering components that may not be used.

Hence, there is a need for improved systems and methods of rendering UI components.

### SUMMARY

In one general aspect, the instant disclosure presents a data processing system having a processor and a memory in communication with the processor wherein the memory stores executable instructions, that when executed by the processor, cause the data processing system to perform multiple functions. The functions include receiving a request to load a UI screen, the UI screen including a first UI component, loading a second UI component in place of the first UI component, where the second UI component imitates an appearance of the first UI component, but requires fewer resources than the first UI component to render, examining user interactions with the UI screen to determine that a user is likely to use the UI component, and responsive to determining that the user is likely to use the UI component, replacing the second UI component with the UI component in the UI screen.

In yet another general aspect, the instant disclosure presents a method for loading a UI component of a UI screen on an as needed basis. In some implementations, the method includes examining a list of UI components included in the UI screen to identify a UI component having an associated replacement UI component, the replacement UI component imitating an appearance of the UI component, but offering fewer functionalities than the UI component, loading the replacement UI component in place of the UI component, examining user interactions with the replacement UI component to determine that the UI component is likely to be used in the near future, and responsive to determining that UI component is likely to be used in the near future, replacing the replacement UI component with the UI component in the UI screen.

In a further general aspect, the instant disclosure presents a non-transitory computer readable medium on which are stored instructions that, when executed, cause a programmable device to perform multiple functions. The functions receiving a request to load an application page, the application page including a component, loading replacement component in place of the component, the replacement component imitating an appearance of the component, but requiring fewer resources than the component to render, examining user interactions with the application page to determine that the component is likely to be used, and responsive to determining that the component is likely to be used, replacing the replacement component with the component in the application page.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 depicts an example UI screen displaying an imitating UI component.

FIG. 3 depicts an example of an original UI component and its corresponding imitating component.

FIG. 4 is a flow diagram depicting an example method for rendering a UI component on an as needed basis.

FIG. 5 is a block diagram illustrating an example software architecture, various portions of which may be used in conjunction with various hardware architectures herein described.

FIG. 6 is a block diagram illustrating components of an example machine configured to read instructions from a machine-readable medium and perform any of the features described herein.

### DETAILED DESCRIPTION

Many webpages and software applications include complicated UI components that require a lot of computation and/or resources to load and render. For example, a component that provides rich text element (RTE) functionalities often takes a lot of time and resources to render and paint on the screen. These components can occur repeatedly in tables, list elements and other places. When a webpage or application page includes multiple such components at different places, the UI screen takes a significant amount of time to load and consumes a lot of memory. This is despite employing techniques such as virtualization and pagination. Moreover, despite taking a lot of time and computing resources to load, many such components are not used by the user viewing the page. Moreover, some of the components are utilized later in time than when the page first loads. Thus, there exists a technical problem of unnecessary rendering of complex components in UI screens. Moreover, there exists another technical problem of increased page load time and memory consumption for rendering UI components that may not be used by the user.

To address these technical problems and more, in an example, this description provides technical solutions for rendering UI components on an as needed basis. This is achieved by enabling the application to display an imitating element in place of a UI component, when the application page is first loaded. Subsequently, user interactions with the UI screen are examined to identify when the user is likely to use the UI component, and the imitating element is replaced with the actual component when it is determined that there is a large likelihood that the user will be utilizing the component soon. User interactions with the UI screen are examined by utilizing listening handlers that monitor certain application events. For example, hover events, click events, pointer events and the like are monitored to determine the position of a pointing element such as a mouse or the user's finger. Depending on the position of the pointing element and/or the application event, a determination is made as to whether the user is likely to move towards the component. When it is determined that the component is likely to be needed soon, the imitating element is replaced with the actual component. In this manner, the technical solution provides an easy-to-use mechanism to render UI components on an as needed basis. This significantly improves UI screen rendering speed and reduces computing resources required for rendering UI screens.

The technical solution described herein addresses the technical problem of inefficient and time-consuming rendering of UI screens that include complex components. The technical solution displays an imitating element in place of a UI component, when the page is first rendered and replaces the imitating element with the actual UI component when there is a need for the UI component. Furthermore, the technical solution stores calculations needed for rendering some UI components such that when such UI components need to be rendered again, the calculations need not be repeated. These techniques increase the speed with which UI screens and webpages are loaded and reduce the amount of memory and processing resources needed to load such pages. The technical effects at least include (1) reducing the amount of time it takes to load UI screens; (2) reducing the amount of memory and processing resources required to load UI screens; and (3) reducing the amount of time and computing resources required to load an already rendered UI component in the same UI screen or across different application sessions.

As will be understood by persons of skill in the art upon reading this disclosure, benefits and advantages provided by such implementations can include, but are not limited to, a technical solution to the technical problems of inefficient loading of UI screens such as webpages and application pages. Technical solutions and implementations provided herein offer a mechanism for rendering complex UI components when needed. The benefits made available by these technology-based solutions provide increased user satisfaction and a reduction in uses of computing resources.

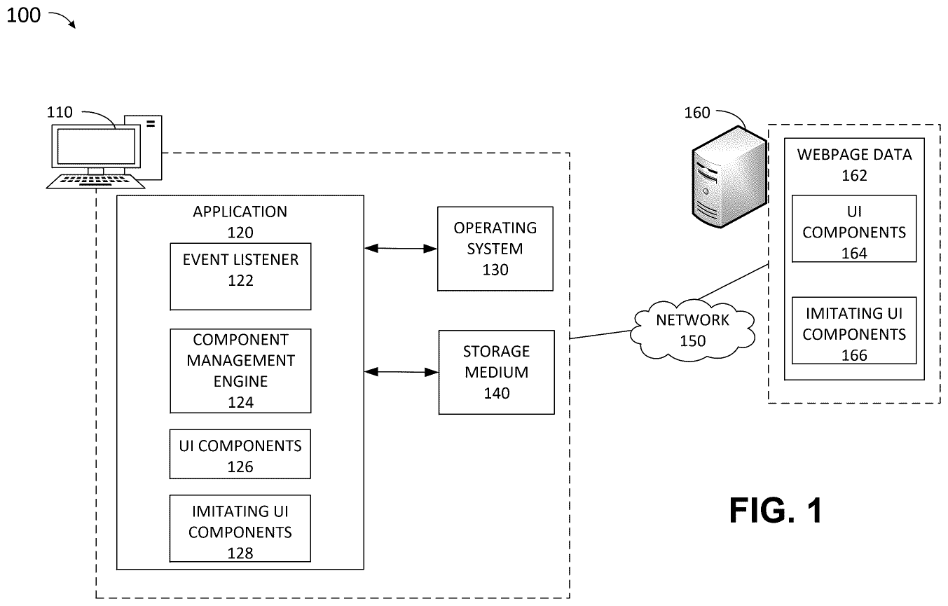

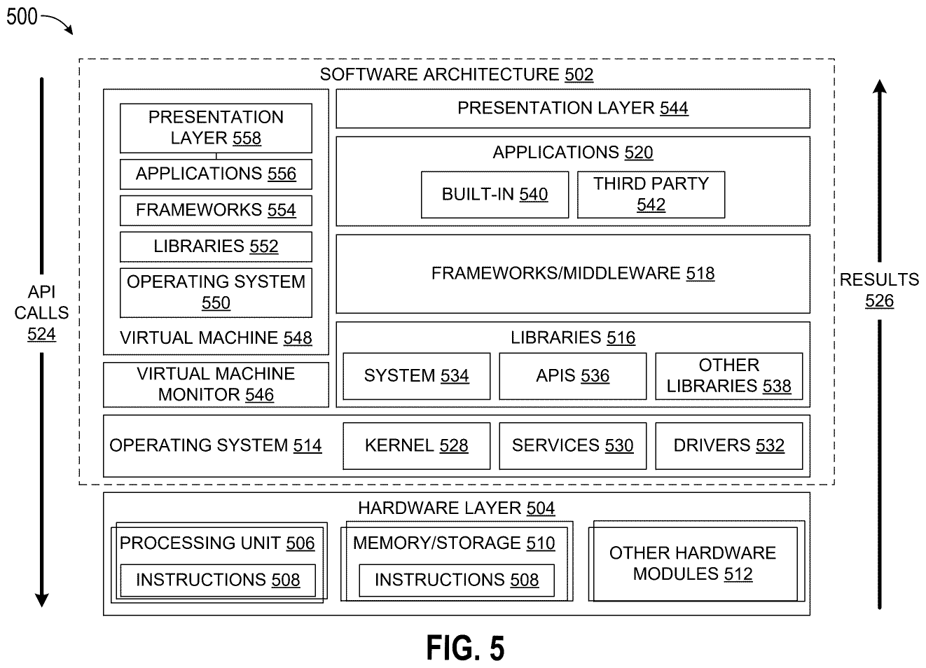

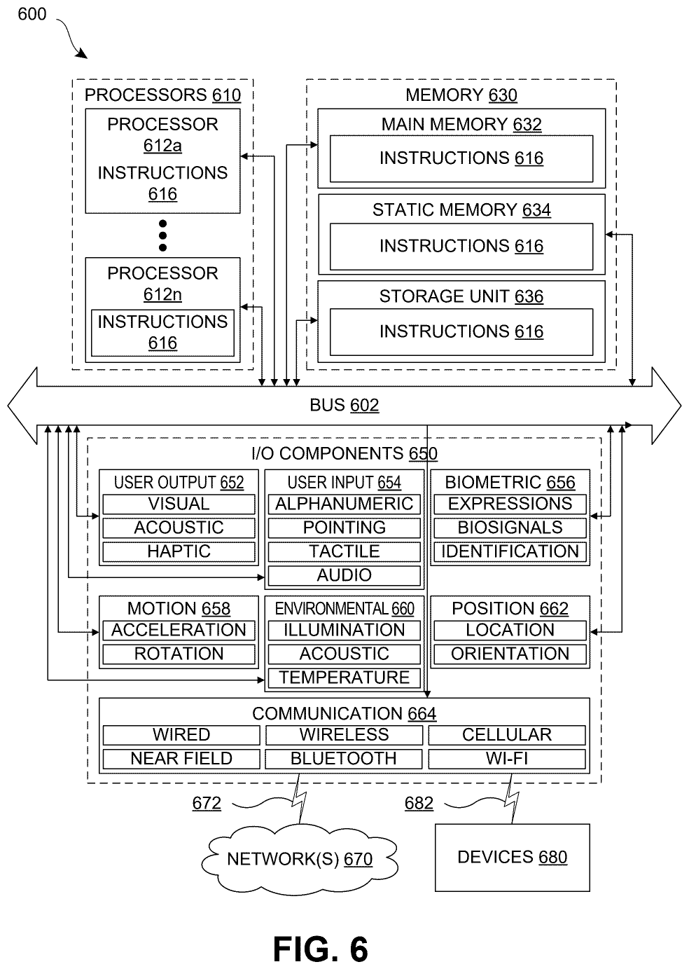

FIG. 1 illustrates an example system 100, upon which aspects of this disclosure may be implemented. The system 100 includes a client device 110 on which a software application such as application 120 is executed. The client device 110 may be a personal or handheld computing device having or being connected to input/output elements that enable a user to interact with the application 120 on the client device 110. Examples of suitable client devices 110 include but are not limited to personal computers, desktop computers, laptop computers, mobile telephones, smart phones, tablets, phablets, digital assistant devices, smart watches, wearable computers, gaming devices/computers, televisions, and the like. The internal hardware structure of a client device is discussed in greater detail in regard to FIGS. 5 and 6.

The application 120 is a software program executed on the client device 110 that configures the device 110 to be responsive to user input to allow a user to interact with the application 120. The application 120 includes a variety of elements that together form a program or suite of programs. In an example, the application 120 includes application code that, when run on the client device 110, executes the application 120 and displays a UI screen associated with the application 120.

To enable display of the UI screen, the application 120 includes UI components 126. The UI components 126 are components that are made available in each UI screen of the application 120. These components may include input controls, radio buttons, dropdown lists, list boxes, toggles, date fields, text fields, navigational components, scroll bar, tags, rich text components, images, and the like. Some of the UI components 126 require extensive computation and/or are otherwise expensive to render. For example, a UI component 126, such as a rich text component can take a long time to load. A UI screen of the application 120 may include multiple such UI components 126. This results in an increased UI screen load time and memory consumption. To reduce the amount of time and resources required to load the UI screen, the application 120 makes use of imitating UI components 128. The imitating UI components 128 are components that have the same appearance as that of the UI components 126 but do not take as much time and resources to load. For example, a rich text component in the UI components 126 may have a corresponding component in the imitating UI components 128, where the corresponding component is a similar looking text node. The text node has the same look as that of the UI component 126 and as a result, appears the same to the user. However, the text node can be loaded much faster, thus reducing the amount of time and resources required to load the UI screen. As such, an imitating UI component 128 functions as a façade that provides an appearance of a UI component without providing the functionalities associated with the UI component. The imitating UI component may be an image or a simple representation of the original UI component. For example, instead of a UI component that provides various text editing functionalities, an image of such a component is used as the imitating component.

In some implementations, the UI components 126 and their corresponding imitating UI components 128 are provided by the developer as part of the code for the application 120. For example, when the developer is designing the UI screen for the application, the developer may determine that some of the UI components required for the UI screen are complex and as such require a lot of resources and/or time to load. The developer can then create an imitating UI component for the expensive UI components and include both the UI components 126 and their corresponding imitating UI components 128 in the code. The UI components 126 that have corresponding imitating UI components 128 are then flagged as being associated with imitating components 128.

The client device 110 includes an operating system 130 for managing the functions of the client device 110 and executing applications such as the application 120. When the application 120 is being mounted or when a new UI screen associated with the application 120 is being loaded, the component management 124 may operate with the operating system 130 to render the imitating UI components 128 instead of the original UI components 126. The component management engine 124 may be an element that is responsible for determining which UI components of the UI screen require replacement and may handle the loading and replacement process.

When a UI component 126 is replaced with a corresponding imitating UI component 128, an event listener 122 is activated in the application 120 to monitor user interactions with respect to the UI screen. The event listener 122 may be provided as part of the code for the application 120 or the component management engine 124 and is activated when an imitating component 128 is loaded during the application mounting or UI screen rendering process. In some implementations, the event listener 122 is attached to the application 120 and/or activated via a JavaScript associated with the application 120. In some implementations, the event listener 122 is a procedure in JavaScript that is designed to look for an event to occur and respond when the event occurs. Examples of events the event listener 122 can detect and process include a mouse click, a key press, hovering over a screen portion, a touch input (e.g., on a touch screen) and the like.

The event listener 122 is connected to an event object that defines the event. For example, an event object may define a hover event as hovering of a pointer over a designated area of the UI screen. An associated event listener 122 would then monitor activities of the pointer to detect when the pointer hovers over the designated area. Event listeners 122 are used, in this manner, to determine when the user is likely to use a UI component 126. When it is determined that the user is likely to use a UI component 126, the event listener 122 may notify the component management engine 124 which may, in turn, replace the imitating UI component 128 with the actual UI component 126. For example, an area around an imitating UI component 128 is designated as a container for the UI component and linked to an event listener 122 that monitors click events, hovers, or pointer movements within that container. Once the pointer reaches the container, the event listener triggers a pointer event, which results in the replacement of the imitating UI component 128 with the actual UI component 126. In this way, when the user attempts to use the UI component 126, the UI component 126 has already been switched and is available for use. This prevents the user from having to wait for the UI component 126 to be loaded, when they attempt to use it. Thus, by predicting the likelihood of the user utilizing a UI component 126, the system 100 is able to load the UI component 126, as needed and just in time, before the user attempts to use it.

In some implementations, when a UI component 126 requires complex computations and/or processing before being loaded, the computations associated with the first rendering of the UI component 126 are stored in a global state in a storage medium, such as the storage medium 140. In this manner, the next time the UI component 126 needs to be loaded, the computations can be reused. This can be useful, when a UI component 126 appears at multiple places in a UI screen or when the UI component 126 can be toggled on/off or be displayed as a pop-up UI element. Furthermore, the computations can be stored and utilized across different application sessions, such that loading of the UI component during a next session of the application also becomes more efficient.

In some implementations, the application 120 is a browser application and the UI screen being loaded is a webpage. In such instances, the webpage data 162 is stored at a remote location such as the server 160 and the client device 110 may retrieve the webpage data 162 via a network 150. It should be noted that the client device 110 can be a mobile telephone having an Android or iPhone Operation System and the application 120 may be an application running on the mobile telephone. The network 150 may be a wired or wireless network(s) or a combination of wired and wireless networks that connect one or more elements of the system 100. The sever 160 is a server that stores data for a webpage that is being accessed via the client device 110. The webpage data 162 includes UI components 164. The UI components 164 are components that are included in the webpage and are provided by the webpage developer. In order to make the loading of the webpage more efficient, the developer can provide a list of imitating UI components 166 that correspond with some of the UI components 164. When a UI component 164 has an associated imitating UI component 166, the imitating UI component is loaded during the initial rendering of the webpage. An event listener 122 is then associated with the imitating UI component to determine when to switch the imitating UI component 166 with the actual UI component 164, in a similar manner as discussed above.

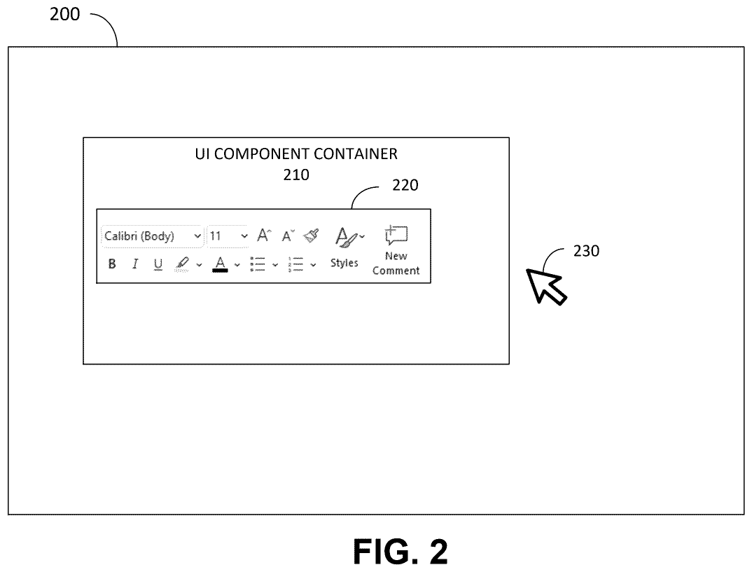

FIG. 2 depicts an example UI screen displaying an imitating UI component. The UI screen 200 may be a UI screen of an application that includes one or more UI components or may be a webpage screen that includes multiple components such as the component 220. The component 220 is an editor UI component that includes multiple features. Each of the features have an associated functionality. As a result, loading the actual UI component requires extensive computation and takes a lot of time and resources. In order to increase the efficiency of rendering the UI screen 200, the UI component 220 is loaded instead of the actual UI editor component. The UI component 220 is an image that imitates the appearance of the of the editor component. Thus, a user viewing the UI screen 200 cannot tell that the UI component 220 is not the actual component.

When loading the UI component 220 in place of the actual UI editor component, a UI component container 210 is created for the imitating UI component 220. The UI component container 210 defines an area surrounding the UI component 220 as the container for the UI component 220. An event listener is then associated with the UI component container 210. The event listener defines an event in association with the UI component container 210. For example, the event listener may look for the pointer 230 crossing the boundary of the UI component container 210 to enter the UI component container 210. When the pointer 230 moves over the UI component container 210, the event listener triggers an event that causes the UI component 220 to be replaced with the actual UI component. In this manner, when the pointer moves close to the UI component 220, the component is replaced with the actual component in anticipation of the need for utilizing the actual component. In some implementations, if an actual component takes a lot of memory (e.g., RAM) or CPU render cycles to maintain for extended time periods, when the pointer 230 navigates away from the UI component, the actual component is exchanged with the imitating component again to further increase efficiency.

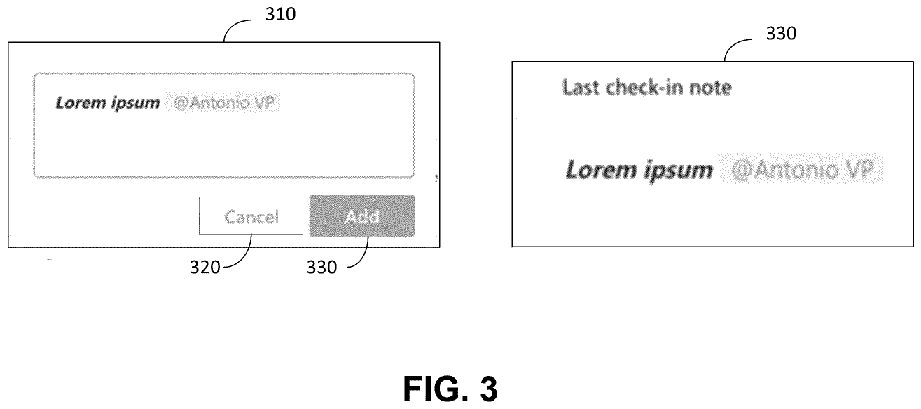

FIG. 3 depicts an example of an original UI component and its corresponding imitating component. The UI element 310 is an original UI component that may be displayed in a UI screen to enable the user to enter text as well as make mentions of other users and generate a link to the other users' contact information (e.g., email address). The UI component 310 may provide an input box when selected (e.g., when it is clicked on). Furthermore, once selected, the UI component 310 provides UI buttons 320 and 330 for canceling the action and adding a comment, respectively. Once text is entered in the input box of the UI component 320 and the button 330 is selected, the UI component 310 displays the entered text as depicted in the UI component 330.

The UI component 330 is an imitating UI component that mimics the appearance of the UI component 310 once a comment is inserted. The UI component 330 displays the same text as the UI component 310 but does not have the functionalities offered by the UI component 310. Thus, if a user clicks on the UI component 330, the input box, and menu buttons 320 and 330 will not be displayed. However, by monitoring user interactions with the screen and utilizing event listeners, the application is able to determine when the user is likely to utilize the UI component 310 and as such can replace the UI component 330 with the actual UI component 310 before the user attempts to utilize the UI component 310.

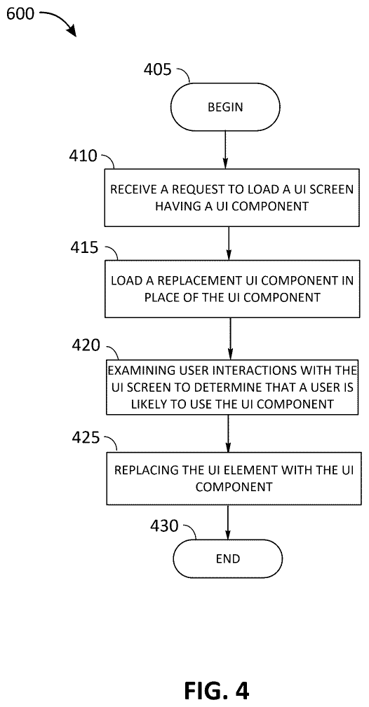

FIG. 4 is a flow diagram depicting an example method for rendering a UI component on an as needed basis. One or more steps of the method 400 may be performed by an application such as the application 120 of FIG. 1 and/or by an operating system that operates in conjunction with the application. The method 400 may begin, at 405, and proceed to receive a request to load a UI screen, at 410. This may occur, for example, when an application is opened (e.g., a request to mount an application is received), when a new UI screen needs to be displayed for an active application or when a webpage is loaded (e.g., a request to access a webpage is received). The UI screen may be a UI screen of the application or a screen of a webpage.

After receiving the request, method 400 proceeds to examine a list of UI components associated with the UI screen to determine if there are any UI components in the UI screen for which a replacement UI component is provided. When a replacement UI component is provided, method 400 proceeds to load the replacement UI component in place of the UI component, at 415, when loading the UI screen. After the UI screen is loaded, method 400 monitors user interactions with the UI screen to determine when a user is likely to use the original UI component, at 420. For example, events such as mouse clicks, pointer movements and hover events are monitored to determine when a pointer is approaching the replacement UI component or is hovering over the UI replacement UI component. When it is determined that the original UI component is likely to be used in the near feature, method 400 proceeds to replace the replacement UI component with the original UI component in the UI screen, at 425, before ending at 430.

FIG. 5 is a block diagram 500 illustrating an example software architecture 502, various portions of which may be used in conjunction with various hardware architectures herein described, which may implement any of the above-described features. FIG. 5 is a non-limiting example of a software architecture and it will be appreciated that many other architectures may be implemented to facilitate the functionality described herein. The software architecture 502 may execute on hardware such as client devices, native application provider, web servers, server clusters, external services, and other servers. A representative hardware layer 504 includes a processing unit 506 and associated executable instructions 508. The executable instructions 508 represent executable instructions of the software architecture 502, including implementation of the methods, modules and so forth described herein.

The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular system. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine depicted in block diagram 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement methods or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660 and/or position components 662, among a wide array of other environmental sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 662 may include, for example, location sensors (for example, a Global Position System (GPS) receiver), altitude sensors (for example, an air pressure sensor from which altitude may be derived), and/or orientation sensors (for example, magnetometers). The motion components 658 may include, for example, motion sensors such as acceleration and rotation sensors. The environmental components 660 may include, for example, illumination sensors, acoustic sensors and/or temperature sensors.

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 662, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:
Item 1. A data processing system comprising:
   a processor; and
   a memory in communication with the processor, the memory comprising executable instructions that, when executed by the processor, cause the data processing system to perform functions of:
   receiving a request to load a user interface (UI) screen, the UI screen including a first UI component;
   loading a second UI component in place of the first UI component, the second UI component imitating an appearance of the first UI component, but requiring fewer resources than the first UI component to render;
   examining user interactions with the second UI screen to determine that a user is likely to use the first UI component; and
   responsive to determining that the user is likely to use the first UI component, replacing the second UI component with the first UI component in the UI screen.
Item 2. The data processing system of item 1, wherein the executable instructions, when executed by the processor, further cause the data processing system to perform functions of:
   responsive to receiving the request to load the UI screen, examining a list of UI components required for the UI screen to identify the first UI component, the first UI component being a component that has an associated second UI component.
Item 3. The data processing system of any of items 1 or 2, wherein the replacement UI component is one of an image that imitates the appearance of the first UI component or a representation of the first UI component that does not provide one or more functionalities provided by the first UI component.
Item 4. The data processing system of any preceding item, wherein the executable instructions, when executed by the processor, further cause the data processing system to perform functions of:
   upon replacing the replacement UI component with the first UI component, storing computations associated with rendering the first UI component in a storage medium for use in subsequent rendering of the first UI component.
Item 5. The data processing system of any preceding item, wherein the executable instructions, when executed by the processor, further cause the data processing system to perform functions of:
   associating an event listener with the second UI component, the event listener monitoring the user interactions with a UI container of the second UI component; and
   responsive to detecting an event associated with the UI container, replacing the second UI component with the first UI component in the UI screen.
Item 6. The data processing system of item 5, wherein the event includes at least one of a click event, a hover event, and a pointer movement event.
Item 7. The data processing system of item 5, wherein the event is a pointer crossing a boundary of the UI container of the second UI component to move toward the second UI component.
Item 8. A method for loading a first user interface (UI) component of a UI screen on an as needed basis comprising:
   examining a list of UI components included in the UI screen to identify a first UI component having an associated second UI component, the second UI component imitating an appearance of the first UI component, but offering fewer functionalities than the first UI component;
   loading the second UI component in place of the first UI component;
   examining user interactions with the second UI component to determine that the first UI component is likely to be used in the near future; and
   responsive to determining that first UI component is likely to be used in the near future, replacing the second UI component with the first UI component in the UI screen.
Item 9. The method of item 8, wherein the UI screen is a graphical user interface of an application.
Item 10. The method of item 9, further comprising receiving a request to mount an application and responsive to receiving the request, examining the list of UI components in a UI screen of the application to identify the first UI component having the associated second UI component.
Item 11. The method of any of items 8-10, wherein the UI screen is a webpage screen.
Item 12. The method of any of items 8-11, wherein the first UI component requires a lot of resources to render.
Item 13. The method of any of items 8-12, wherein the first UI component and the second UI component are provided in a software code associated with the UI screen.
Item 14. The method of any of items 8-13, wherein examining user interactions with the UI screen includes monitoring events associated with the UI screen to determine when a user is likely to use the first UI component.
Item 15. The method of any of items 8-14, wherein examining user interactions with the UI screen includes monitoring events associated with the UI screen to determine when a pointer is approaching the second UI component.
Item 16. A non-transitory computer readable medium on which are stored instructions that, when executed, cause a programmable device to perform functions of:
   receiving a request to load an application page, the application page including a component;
   loading replacement component in place of the component, the replacement component imitating an appearance of the component, but requiring fewer resources than the component to render;
   examining user interactions with the application page to determine that the component is likely to be used; and
   responsive to determining that the component is likely to be used, replacing the replacement component with the component in the application page.
Item 17. The data processing system of item 16, wherein the instructions when executed further cause the programmable device to perform functions of:
   responsive to receiving the request to load the application page, examining a list of components required for the application page to identify the component, the component being a component that has an associated replacement component.
Item 18. The data processing system of any of items 16 or 17, wherein the instructions when executed further cause the programmable device to perform functions of:
   upon replacing the replacement component with the component, storing computations associated with rendering the component in a storage medium for use in subsequent rendering of the component.
Item 19. The data processing system of any of items 16-18, wherein the instructions when executed further cause the programmable device to perform functions of:
   responsive to replacing the replacement component with the component in the application page, monitoring user interactions with the application page to determine that a user is no longer likely to use the component; and
   responsive to determining that the user is no longer likely to use the component, replacing the component with the replacement component.
Item 20. The data processing system of any of items 16-19, wherein examining user interactions with the application page includes monitoring events associated with the application page to determine when a user is likely to use the component.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

1. A data processing system comprising:
a processor; and
a memory in communication with the processor, the memory comprising executable instructions that, when executed by the processor, cause the data processing system to perform functions of:
receiving a request to load a user interface (UI) screen, the UI screen including a plurality of UI components;
responsive to receiving the request, determining that there is a first UI component among the plurality of UI components, the first UI component being a UI component for which a replacement UI component is provided as part of a code for the UI screen;
upon determining that there is the first UI component among the plurality of UI components, loading a replacement UI component instead of the first UI component, the replacement UI component imitating an appearance of the first UI component, but requiring fewer resources than the first UI component to render;
examining user interactions with the replacement UI component to determine that a user is likely to use the first UI component; and
responsive to determining that the user is likely to use the first UI component, replacing the replacement UI component with the first UI component in the UI screen.

2. The data processing system of claim 1, wherein the executable instructions, when executed by the processor, further cause the data processing system to perform functions of:
responsive to receiving the request to load the UI screen, examining a list of the plurality of UI components required for the UI screen to identify the first UI component.

3. The data processing system of claim 1, wherein the replacement UI component is one of an image that imitates the appearance of the first UI component or a representation of the first UI component that does not provide one or more functionalities provided by the first UI component.

4. The data processing system of claim 1, wherein the executable instructions, when executed by the processor, further cause the data processing system to perform functions of:
upon replacing the replacement UI component with the first UI component, storing computations associated with rendering the first UI component in a storage medium for use in subsequent rendering of the first UI component.

5. The data processing system of claim 1, wherein the executable instructions, when executed by the processor, further cause the data processing system to perform functions of:
associating an event listener with the replacement UI component, the event listener monitoring the user interactions with a UI container of the replacement UI component; and
responsive to detecting an event associated with the UI container, replacing the replacement UI component with the first UI component in the UI screen.

6. The data processing system of claim 5, wherein the event includes at least one of a click event, a hover event, and a pointer movement event.

7. The data processing system of claim 5, wherein the event is a pointer crossing a boundary of the UI container of the replacement UI component to move toward the replacement UI component.

8. A method for loading a first user interface (UI) component of a UI screen on an as needed basis comprising:
examining a list of a plurality of UI components included in the UI screen to identify a first UI component, from among the plurality of UI components, the first UI component being a UI component for which an associated replacement UI component is provided as part of a code for the UI screen, the replacement UI component imitating an appearance of the first UI component, but offering fewer functionalities than the first UI component;
upon identifying the first UI component for which the replacement UI component is provided, loading the replacement UI component instead of the first UI component;
examining user interactions with the replacement UI component to determine that the first UI component is likely to be used; and
responsive to determining that the first UI component is likely to be used, replacing the replacement UI component with the first UI component in the UI screen.

9. The method of claim 8, wherein the UI screen is a graphical user interface of an application.

10. The method of claim 9, further comprising receiving a request to mount an application, and responsive to receiving the request, examining the list of the plurality of UI components in the UI screen of the application to identify the first UI component having the associated replacement UI component.

11. The method of claim 8, wherein the UI screen is a webpage screen.

12. The method of claim 8, wherein the first UI component requires a large number of resources to render.

13. The method of claim 8, wherein the first UI component and the replacement UI component are provided in a software code associated with the UI screen.

14. The method of claim 8, wherein examining user interactions with the UI screen includes monitoring events associated with the UI screen to determine when a user is likely to use the first UI component.

15. The method of claim 8, wherein examining user interactions with the UI screen includes monitoring events associated with the UI screen to determine when a pointer is approaching the replacement UI component.

16. A non-transitory computer readable medium on which are stored instructions that, when executed, cause a programmable device to perform functions of:
receiving a request to load an application page, the application page including a plurality of components, the plurality of components including a component for which a replacement component is provided as part of a code for the application page;
responsive to receiving the request, loading the replacement component instead of the component, the replacement component imitating an appearance of the component, but requiring fewer resources than the component to render;
examining user interactions with the application page to determine that the component is likely to be used; and
responsive to determining that the component is likely to be used, replacing the replacement component with the component in the application page.

17. The non-transitory computer readable medium of claim 16, wherein the instructions when executed further cause the programmable device to perform functions of:
responsive to receiving the request to load the application page, examining a list of the plurality of components required for the application page to identify the component.

18. The non-transitory computer readable medium of claim 16, wherein the instructions when executed further cause the programmable device to perform functions of:
upon replacing the replacement component with the component, storing computations associated with rendering the component in a storage medium for use in subsequent rendering of the component.

19. The non-transitory computer readable medium of claim 16, wherein the instructions when executed further cause the programmable device to perform functions of:
responsive to replacing the replacement component with the component in the application page, monitoring user interactions with the application page to determine that a user is no longer likely to use the component; and
responsive to determining that the user is no longer likely to use the component, replacing the component with the replacement component.

20. The non-transitory computer readable medium of claim 16, wherein examining user interactions with the application page includes monitoring events associated with the application page to determine when a user is likely to use the component.

21. The data processing system of claim 1, wherein the executable instructions, when executed by the processor, further cause the data processing system to perform functions of:
determining that there are two UI components among the plurality of UI components, for each of which one replacement UI component is provided as part of the code for the UI screen; and
when loading the UI screen, for each of the two UI components, loading the one replacement UI component that corresponds to each of the two UI components, instead of each of the two UI components.

22. The data processing system of claim 1, wherein the replacement UI component is not an image of all UI components of the UI screen.

23. The data processing system of claim 1, wherein the code for the UI screen includes both the UI component and its corresponding replacement UI component.
